(19) United States
(12) Patent Application Publication
(10) Pub. No.: US 2019/0061085 A1
(43) Pub. Date: Feb. 28, 2019

(54) SPINDLE APPARATUS FOR USE ON A NUMERICALLY CONTROLLED MACHINE TOOL

(71) Applicant: DECKEL MAHO Pfronten GmbH, Pfronten (DE)

(72) Inventors: Robert JUNG, Pfronten (DE); Hans VEITTINGER, Kempten (DE)

(21) Appl. No.: 16/108,169

(22) Filed: Aug. 22, 2018

(30) Foreign Application Priority Data
Aug. 23, 2017 (DE) 10 2017 007 857.2

(51) Int. Cl. B23Q 17/00; B23Q 17/09; B23Q 3/12; B23Q 15/14

(52) U.S. Cl. CPC B23Q 17/005; B23Q 17/0966; B23Q 17/2216; B23Q 15/14; B23Q 3/12

(57) ABSTRACT

The present invention relates to a spindle apparatus 100 for use on a numerically controlled machine tool, which spindle apparatus 100 has the following: a spindle housing 1, and a spindle shaft 15 which is mounted in the spindle housing, the spindle apparatus 100 having, furthermore, an electrically earthed section 4 which holds at least one rod element 20 which comprises an electrically conductive material, and the at least one rod element 20 being arranged in such a way that it makes contact with the spindle shaft 15 so as to bear tangentially against an outer circumference of the spindle shaft 15.

The present invention relates to a spindle apparatus for use on a numerically controlled machine tool.

### BACKGROUND OF THE INVENTION

Machine tools such as milling machines, lathes or grinding machines are currently state of the art in the field of the precise production of workpieces. Here, precision and reproducibility has been improved continuously in the past years in the case of machine tools; firstly by way of drives which can be actuated very precisely, but also by way of very accurate measuring systems which monitor the production process using a very wide variety of parameters and thus constantly give feedback to the controller about the actual state of the machining operation.

DE 10 2013 201 328 A1 has disclosed a machining unit for a machine tool, which machining unit detects the movement of the spindle axis by means of an axially measuring sensor and a radially measuring sensor, which movement can occur on account of chips which adhere at the cut surface or other impurities from a previous machining process. On the basis of the detected data, the controller can correspondingly bring about a compensation of the incorrect position of the spindle axis.

In addition, DE 20 2015 001 082 U1 has disclosed a spindle apparatus for a program-controlled machine tool, which spindle apparatus has a sensor system device which is arranged on the spindle housing and has at least one structure-borne sound sensor which is set up to detect structure-borne soundwaves or vibrations which occur in the case of grinding processes.

The problem occurs here that the highly sensitive measuring devices, such as structure-borne sound sensors or vibration sensors, but also pressure sensors and acceleration sensors, had partially considerable deviations and/or fluctuations in their measured data. The result of tests in respect of the said observations is that the measuring devices were influenced, inter alia, by the electric charging of the spindle shaft of the working spindle, which electric charging is caused, for example, by the frequency-regulated actuation of the spindle motors, and the measured values were subject to a high variance as a result, which can have a negative effect on the precision of the machine tool.

### SUMMARY OF THE INVENTION

It is therefore an object of the present invention to provide a spindle device for use on a numerically controlled machine tool, by way of which spindle device the above problems are avoided.

The said object is achieved by way of a spindle apparatus according to claim 1. The dependent claims relate to advantageous exemplary embodiments of the spindle apparatus according to the invention.

The spindle apparatus according to the invention for use on a numerically controlled machine tool has: a spindle housing, and a spindle shaft which is mounted in the spindle housing, the spindle apparatus having, furthermore, an electrically earthed section which holds at least one rod element which comprises an electrically conductive material, and the at least one rod element being arranged in such a way that it makes contact with the spindle shaft so as to bear tangentially against an outer circumference of the spindle shaft.

The spindle apparatus according to the invention ensures that electric charges which are potentially produced at any time are discharged on the surrounding, earthed part of the working spindle. This avoids a situation where an electric potential which is built up influences the sensitive measuring devices. The accuracy of the measured values is increased and/or the variants of the measured values is decreased. As a result, the machine tool can in turn be controlled more precisely.

In particular, the spindle apparatus according to the invention affords the advantage that automatic adjustment of the rod elements can take place by way of the rod elements bearing tangentially against the spindle shaft, it being possible for the rod elements to press with a prestress on the spindle shaft, with the result that at least one of the rod elements is always in contact with the spindle shaft and the electric potential can thus be discharged. This is particularly advantageous, since there is a certain amount of wear on the rod element as a result of the friction between the rod element and the spindle shaft.

If the rod element is then excessively worn, the construction of the spindle apparatus according to the invention additionally affords the advantageous possibility of easily changing the rod elements which are used, since they can be removed in a few steps from the bores which are provided for this purpose and can be replaced by new rod elements.

A further, particularly advantageous aspect of the spindle apparatus according to mention is that the rod elements and therefore the discharge of the electric potential of the spindle shaft are very close to the sensitive measuring devices.

Since the measuring devices are attached close to the tool or workpiece in most cases, in order to obtain measured values which are as precise as possible, the said measuring devices are also provided close to the receiving apparatus of the spindle shaft. It is therefore advantageous if the earthing of the spindle shaft also takes place close to the receiving apparatus or rather to the sensitive measuring devices.

It is unimportant here how the said receiving apparatus is configured. Both tools and/or workpieces can be received in the said receiving apparatus, usually by way of standardized interfaces (for example, hollow shaft cone or steep angle taper, etc.), but also very much by way of manufacturer-specific interfaces.

One particularly advantageous development of the spindle apparatus consists in that the at least one rod element is configured as a carbon fibre rod element.

The use of carbon fibre as a rod element has the advantage that, in addition to a satisfactory electric conductivity, it also has a lower friction with the friction partner in comparison with rod elements made from metallic material. Frictional resistances of the spindle shaft can thus be kept comparatively low, and an optimum discharge of the electric potential of the spindle shaft can nevertheless be guaranteed.

In addition, carbon generally affords the advantage that it is a very resistant material to mechanical actions. It is therefore recommended to use the said material in regions which are loaded mechanically to a relatively great extent.

A further particularly advantageous development of the spindle apparatus consists in that the electrically earthed section of the spindle apparatus and a receiving apparatus for receiving tools and/or workpieces are provided on an end side of the spindle shaft.

In addition, a particularly advantageous development of the spindle apparatus results from the fact that, furthermore, a sensor device is provided on the end side of the spindle shaft, which sensor device has, in particular, at least one vibration sensor for detecting vibrations and/or a structure-borne sound sensor for detecting structure-borne sound waves or vibrations.

As a result, as has already been described further above, the electric potential which is produced can be discharged from the spindle shaft along a path which is as short as possible, in order to bring about influencing of the measuring devices which is as low as possible or in order to completely avoid the said measuring devices being influenced by way of an electric potential.

A further advantageous development of the spindle apparatus consists in that the electrically earthed section is of partially annular, annular or hollow-cylindrical configuration, the spindle shaft extending through an internal diameter of the electrically earthed section.

As a result, it is possible to move the rod elements as close as possible to the receiving apparatus of the spindle shaft.

One advantageous development of the spindle apparatus consists in that the electrically earthed section has at least one bore, in which the rod element is held in the electrically earthed section.

In addition, one advantageous development of the spindle apparatus results from the fact that the bore, in which the rod element is held, is of secant-shaped configuration in the electrically earthed section, in such a way that the rod element which is held in the bore makes contact with the spindle shaft in a tangentially bearing manner.

The shaping of the bore and its position in relation to the spindle shaft make extremely advantageous bearing of the rod element against the spindle shaft possible, with the result that contact between the rod element and the spindle shaft already arises as a result of the introduction of the rod element into the bore.

One particularly advantageous development of the spindle apparatus consists in that the electrically earthed section holds at least two rod elements, and each rod element makes contact with the spindle shaft in each case so as to bear tangentially against the outer circumference of the spindle shaft.

In addition to the use of one rod element as a discharging element for the electric potential which can be produced in the spindle shaft, a plurality of rod elements are advantageous, since, in the case of a loss of contact of one of the rod elements, the other rod element or the other rod elements is/are still in contact with the spindle shaft and can reliably discharge the electric potential to the earthed part of the working spindle.

Furthermore, higher potentials (potential spikes) can also be discharged reliably by way of a plurality of rod elements, without damaging the rod elements or other parts of the working spindle in the process, for example by way of sparking.

A further advantageous development of the spindle apparatus consists in that the normals of the rod elements which make contact tangentially with the outer circumference of the spindle shaft lie at an angle of from 45° to 135° with respect to one another.

Fixedly defined angular spacings can also be advantageous, however, such as 35°, 75°, 85° and the like, or a symmetrical arrangement of the rod elements (4×90°, 3×120°, etc.). Here, the stated values are only examples, with the result that the invention is not restricted to the stated values.

One particularly advantageous development of the spindle apparatus consists in that the at least one rod element makes contact with the spindle shaft so as to bear tangentially under an elastic deformation.

This makes it possible that the rod element is always in contact with the spindle shaft, even if vibrations in the spindle shaft or wear of the rod element occur/occurs.

A further advantageous development of the spindle apparatus consists in that the spindle apparatus has at least one resilient element for each rod element, which resilient element presses the respective rod element onto the outer circumference of the spindle shaft.

As a result, in addition to the force of the elastic deformation of the rod element, the pressing force of the rod element on the spindle shaft can be increased, in order to secure the earthed state of the spindle shaft.

One particularly advantageous development of the spindle apparatus consists in that, furthermore, the resilient element has a thread-shaped setting apparatus, by means of which the force which presses the rod element onto the outer circumference of the spindle shaft can be set.

It is particularly advantageous if that force of the resilient element which additionally acts on the rod element can be set in an infinitely variable manner. This can very advantageously take place by way of a threaded pin or screw. In the case of a corresponding thread selection and tool size, furthermore, the force of the resilient element can be set in a very precise manner.

A further advantageous development of the spindle apparatus consists in that the rod element has a sleeve in each case at the two ends, which sleeve is in contact with the electrically earthed section in a flatly bearing manner.

In order that a problem-free and reliable discharge of the electric potential is ensured, it is additionally advantageous if the contact between the rod element and the earthed part of the working spindle has an area which is as great as possible, in order that potential spikes can also be discharged, without the contact points between the rod element and the earthed part of the working spindle being damaged in the process, for example on account of sparking.

One particularly advantageous development of the spindle apparatus consists in that at least one sleeve on each rod element has a thread for fastening the rod element in the electrically earthed section.

For effective fastening of the rod elements, it is advantageous if the said rod elements are secured in the earthed part of the working spindle against unwanted movement by means of a thread. As an alternative, however, a screw can also secure the respective rod element in the spindle apparatus.

Electric potentials which occur on the spindle shaft and have a negative effect on the measuring devices of the machine tool can be discharged effectively by way of the spindle apparatus according to the invention, and the accuracy of the machine tool can be increased as a result.

Further aspects and their advantages, and also advantages and more specific design options of the above-described aspects and features will be described in the following descriptions and explanations in respect of the appended figures, which descriptions and explanations are not to be interpreted as restrictive in any way at all.

### BRIEF DESCRIPTION OF THE FIGURES

FIG. 1 shows an exemplary diagrammatic perspective exploded illustration of a spindle apparatus for a numerically controlled machine tool, which spindle apparatus has a sensor system device,

FIG. 2 shows an exemplary diagrammatic illustration of a spindle apparatus for a numerically controlled machine tool in a side view and a sectional view in accordance with one exemplary embodiment of the present invention.

### DETAILED DESCRIPTION OF THE FIGURES AND PREFERRED EXEMPLARY EMBODIMENTS OF THE PRESENT INVENTION

In the following text, examples and exemplary embodiments of the present invention will be described in detail with reference to the appended figures. Here, identical or similar elements in the figures can be denoted by identical reference numerals, but sometimes also by different reference numerals.

It is to be emphasized that the present invention is not limited or restricted in any way to the exemplary embodiments which are described in the following text and their embodiment features, but rather also includes modifications of the exemplary embodiments, in particular those which are included within the scope of protection of the independent claims as a result of modifications of the features of the described examples and/or by way of combination of single or multiple features of the described examples.

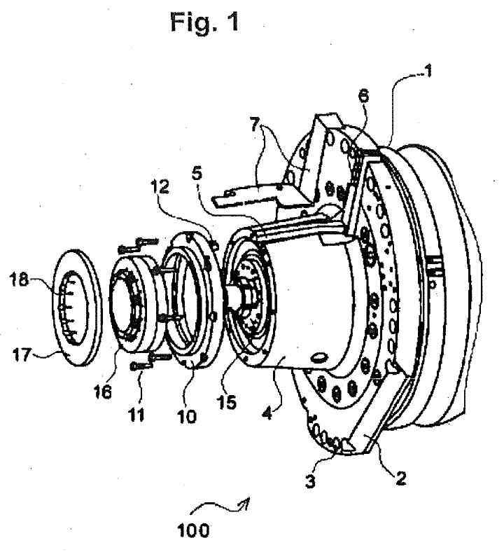

FIG. 1 shows an exemplary diagrammatic perspective exploded illustration of a spindle apparatus 100 for a numerically controlled machine tool (not shown), which spindle apparatus 100 has a sensor system device.

In particular, FIG. 1 shows an exemplary diagrammatic perspective exploded illustration of parts of a spindle apparatus 100 of a working spindle, in particular of a tool-carrying working spindle, for a numerically controlled machine tool (not shown).

The machining unit which is shown by way of example and has a working spindle or spindle apparatus 100 is set up, for example, to carry out milling and/or drilling work on workpieces which are clamped on workpiece clamping means of the machine tool, for example with the use of tools (not shown in FIG. 1), in particular milling and drilling tools which can usually be clamped on the spindle shaft or spindle apparatus with the use of tool interfaces which can be interchanged on the spindle shaft, and are then driven rotationally at high rotational speeds by way of the spindle shaft or spindle apparatus in order to generate or to drive the cutting movement.

One or more of the machining units having a spindle shaft or spindle apparatuses 100 of a working spindle can be provided, for example, for machining or manufacturing workpieces for or on the machine tools, in particular on program-controlled or numerically controllable machine tools, such as milling machines, milling machines/lathes, universal milling machines, universal machine tools or CNC machining centres which have one or more tool-carrying working spindles.

Tools can typically be received on spindle shafts of this type on receiving apparatuses or tool receptacles of the spindle shafts by way of tool interfaces, such as tool cones, in particular Morse tapers, steep angle tapers or hollow shaft cones, in order then to be driven on the working spindle. They can be a very wide variety of drilling or milling tools or other tools which are each clamped or fixed on the typically standardized tool interface or the tool cone.

The machining unit/spindle apparatus 100 in accordance with FIG. 1 comprises, by way of example, a spindle housing 1 which can be fastened to a further component of the machine tool or can be assembled with the latter, in particular by way of a spindle head carrier or a swivel head of the machine tool, to be precise optionally with the aid of an annular flange 2 which has a multiplicity of axial bores 3 for fastening to or assembling with further components of the machine tool. The spindle shaft 15 is mounted rotatably in the interior of the housing 1.

By way of example, a frustoconical housing part 4 (electrically earthed section) of the machining unit/spindle apparatus 100 is fastened to the front side of the annular flange 2, in the circumferential wall of which frustoconical housing part 4 one (or more) outwardly open longitudinal groove/grooves 5 is/are machined by way of example. The longitudinal groove 5 is continued by way of example in a receiving groove 6 which is configured by way of example in the annular flange 2. The longitudinal groove 5 and its continuation, that is to say, for example, the receiving groove 6, by way of example form a receiving channel for a power and/or measured data cable (not shown in FIG. 1) which is laid in the said receiving channel 5, 6 and can subsequently be covered by way of a shaped metal sheet 7 which is fastened releasably to the housing part 4.

In front of the front end of the housing part 4, FIG. 1 shows by way of example a first ring element 10 which can be fastened releasably to the end side of the housing part 4, by way of example by way of a plurality of fastening elements 11 (for example, threaded bolts). The first ring element 10 has, by way of example, a profiled cross section and is supported, by way of example, with its right-hand (in FIG. 1) end face (that is to say, in particular, with the side which faces the spindle), on the left-hand annular end face of the housing part 4 or is attached on the latter or fastened releasably to the latter.

At the front end of the spindle shaft 15, a second ring element 16 is fastened releasably to the first ring element 10 by way of a plurality of fastening means (for example, stud bolts), the second ring element 16 rotating together with the spindle shaft 15 and being capable of providing a rotor as a consequence.

The second ring element 16 has, by way of example, a cylindrical inner circumferential face and, by way of example, a stepped cross section. The second ring element 16 is covered, by way of example, by way of an annular covering element 17 which is fastened releasably to the, by way of example, planar end face of the spindle in planar contact with the aid of fastening means (for example, stud bolts 18), and closes off the spindle shaft with the exposure of the tool receptacle for clamping in a tool shank on the end side.

By way of example, receiver and/or transmission means can be accommodated in the first ring element 10, which receiver and/or transmission means can serve for the contactless transmission of measured data, sensor signals and/or power signals. Furthermore, by way of example, a cable passage section 12 for the electric connection to the sensor system is provided on the first ring element 10 (for example, connection of the power and/or measuring cable to the receiver and/or transmission means), which cable passage section 12 lies opposite the cable channel of the longitudinal groove 5 and can protrude into the said cable channel in the mounted state.

One or more sensors can be accommodated in the second ring element 10. These can comprise, for example, sensors, for example vibration sensors, by way of which operation-related deformations of the spindle and/or the spindle head in the axial direction and also in the circumferential direction can be detected. Different sensor types, for example sensors which are sensitive to pressure, stress or force, are suitable as sensing elements, in order to detect, for example, misalignments of the spindle and/or shape changes.

The sensor system possibly comprises an evaluation unit which is coupled electronically to the different sensors, performs an evaluation and also storage of the detected data, and can be controlled by microprocessor. The wear values of the cutting tools and possible damage of machine components as a result of impact collisions can also be detected, stored and correspondingly taken into consideration in the machine controller with the aid of the said sensor system. Furthermore, it is possible by way of vibration sensors to carry out unbalanced measurements and/or to detect bearing damage of bearings of the spindle shaft on the basis of an evaluation of the measured signals.

A cable (measuring and/or power cable) is laid in the cable channel 5 of the housing part 4 as far as into the stationary outer ring (first ring element 10) which is connected fixedly to the spindle housing part 4. Connectors for the power and measured data cable are possibly situated in the said outer ring (first ring element 10), it also being possible for the said power or measuring cable to be connected to a transmission element which is arranged in the stationary outer ring (first ring element 10), and the counter-element (receiver element) of which can be situated in the rotor ring (second ring element 16) which rotates with the spindle.

The above-described spindle apparatus 100 is to be understood merely as an example for a spindle apparatus, as is currently state of the art and for which purpose a sensor system is used in or on the spindle shaft 15. A different spindle apparatus 100 can however also indeed have different components and sensors and can detect different or further parameters for monitoring the machining process. The embodiments of the described invention can be applied on the above-described spindle apparatus 100 and also on different spindle apparatus is which are not described here in detail.

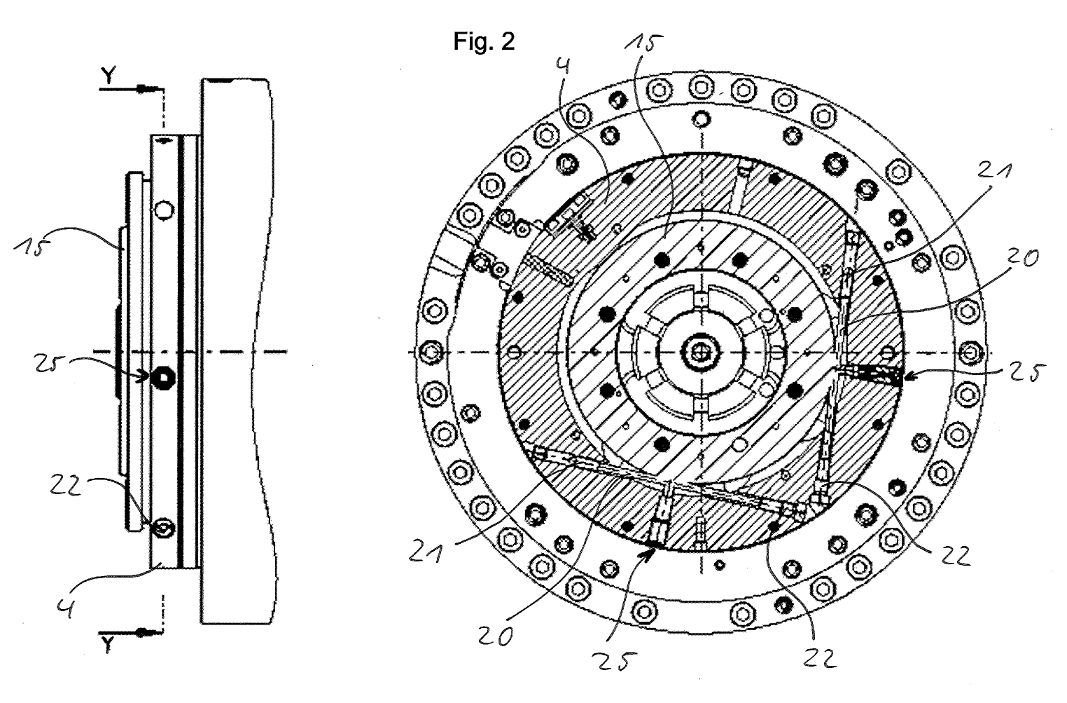

FIG. 2 shows an exemplary diagrammatic illustration of a spindle apparatus 100 for a numerically controlled machine tool (not shown) in a side view and a sectional view in accordance with one exemplary embodiment of the present invention.

Here, by way of example, two rod elements 20 can be seen in the sectional view, which rod elements 20 have, in each case at one end, a sleeve 21 with a conically tapering end and a thread 22 which can also be applied on a sleeve and can then be pressed onto the rod element. However, the thread 22 can also be replaced by a threaded pin or by a screw, depending on the application and installation space.

Here, as planar a contact as possible is to be produced between 8 rod element 20 and housing part 4 (electrically earthed section) by way of the sleeves 21 which are used. Only this can ensure that even high potential spikes can be discharged from the spindle shaft 15 and cannot damage or overload the surrounding material in the process. In addition, a planar contact of the sleeve/sleeves 21 affords the advantage that rattling of the rod element 20 can be reduced or avoided. Furthermore, a conically tapering end of the sleeve 21 (as shown in FIG. 2) is advantageous in so far as, during the insertion of the rod element 20 into the spindle apparatus 100, the risk of tilting of the rod element 20 in the housing part 4 or on the spindle shaft 15 can be reduced. This facilitates the mounting of the rod elements 20 to a considerable extent.

The thread 22 or a threaded pin or a screw secures the rod element 20 against movement within the spindle apparatus 100. Furthermore, “rattling” of the rod element 20 within the spindle apparatus 100 can be reduced or avoided by way of the securing using a thread 22.

In addition, it can be seen in the sectional view of FIG. 2 how, by way of example, a resilient element 25 is provided on each rod element 20, in order to press the respective rod element 20 onto the spindle shaft 15 with an increased force.

This ensures that the rod element 20 remains reliably in contact with the spindle shaft 15 even in the case of pronounced vibrations which occur during the workpiece machining.

That force of the resilient element 25 which acts on the rod element 20 can advantageously be set by way of a thread-shaped setting apparatus, furthermore. The pressing force of the rod element 20 on the spindle shaft 15 can thus be increased or decreased in a very precisely metered manner. In addition, the setting by way of the thread shape can take place in an infinitely variable manner and does not require any additional securing means in most cases. A further advantage in the case of the use of a thread on the resilient element 25 is that the resilient element 25 can be dismantled very easily in the case of a replacement of the rod element 20, and can also be inserted again easily after the replacement of the rod element 20.

In the above text, examples and exemplary embodiments of the present invention and their advantages have been described in detail with reference to the appended figures.

It is to be emphasized again that the present invention is not limited or restricted in any way at all, however, to the above-described exemplary embodiments and their embodiment features, but rather comprises, furthermore, modifications of the exemplary embodiments, in particular those which are included within the scope of protection of the independent claims by way of modifications of the features of the described examples and/or by way of combination of single or multiple features of the described examples.

### LIST OF REFERENCE NUMERALS

1 Spindle housing

2 Annular flange

3 Axial bore

4 Electrically earthed section/housing part

5 Open longitudinal groove

6 Receiving groove

7 Shaped metal sheet

10 First ring element

11 Fastening plate

12 Cable passage section

15 Spindle shaft

16 Second ring element

17 Annular covering element

18 Stud bolts

20 Rod element

21 Sleeve

22 Thread of the rod element

25 Resilient element

100 Spindle apparatus

1. Spindle apparatus for use on a numerically controlled machine tool, having:
a spindle housing, and
a spindle shaft which is mounted in the spindle housing,
the spindle apparatus having, furthermore, an electrically earthed section which holds at least one rod element which comprises an electrically conductive material, and
the at least one rod element being arranged in such a way that it makes contact with the spindle shaft so as to bear tangentially against an outer circumference of the spindle shaft.

2. Spindle apparatus according to claim 1, characterized in that the at least one rod element is configured as a carbon fiber rod element.

3. Spindle apparatus according to claim 1, characterized in that the electrically earthed section of the spindle apparatus and a receiving apparatus for receiving tools and/or workpieces on an end side of the spindle shaft are provided.

4. Spindle apparatus according to claim 3, characterized in that, furthermore, a sensor device is provided on the end side of the spindle shaft, which sensor device has, in particular, at least one vibration sensor for detecting vibrations and/or a structure-borne sound sensor for detecting structure-borne sound waves or vibrations.

5. Spindle apparatus according to claim 1, characterized in that the electrically earthed section is of partially annular, annular or hollow-cylindrical configuration, the spindle shaft extending through an internal diameter of the electrically earthed section.

6. Spindle apparatus according to claim 1, characterized in that the electrically earthed section has at least one bore, in which the rod element is held in the electrically earthed section.

7. Spindle apparatus according to claim 6, characterized in that the bore, in which the rod element is held, is of secant-shaped configuration in the electrically earthed section, in such a way that the rod element which is held in the bore makes contact with the spindle shaft in a tangentially bearing manner.

8. Spindle apparatus according to claim 1, characterized in that the electrically earthed section holds at least two rod elements, and each rod element makes contact with the spindle shaft in each case as to bear tangentially against the outer circumference of the spindle shaft.

9. Spindle apparatus according to claim 8, characterized in that the normals of the rod elements which make contact tangentially with the outer circumference of the spindle shaft lie at an angle of from 45° to 135° with respect to one another.

10. Spindle apparatus according to claim 1, characterized in that the at least one rod element makes contact with the spindle shaft so as to bear tangentially under an elastic deformation.

11. Spindle apparatus according to claim 1, characterized in that the spindle apparatus has at least one resilient element for each rod element, which resilient element presses the respective rod element onto the outer circumference of the spindle shaft.

12. Spindle apparatus according to claim 11, characterized in that, furthermore, the resilient element has a thread-shaped setting apparatus, by means of which the force which presses the rod element onto the outer circumference of the spindle shaft can be set.

13. Spindle apparatus according to claim 1, characterized in that the rod element has a sleeve in each case at the two ends, which sleeve is in contact with the electrically earthed section in a flatly bearing manner.

14. Spindle apparatus according to claim 13, characterized in that at least one sleeve on each rod element has a thread for fastening the rod element in the electrically earthed section.
